(19) United States
(12) Patent Application Publication
(10) Pub. No.: US 2013/0241191 A1
(43) Pub. Date: Sep. 19, 2013

(54) PRESSURE-RATED SPLINE JOINT

(71) Applicant: J-M MANUFACTURING COMPANY, INC., Los Angeles, CA (US)

(72) Inventor: Randall Sackewitz, Valdosta, GA (US)

(73) Assignee: J-M Manufacturing Company, Inc., Los Angeles, CA (US)

(21) Appl. No.: 13/798,460

(22) Filed: Mar. 13, 2013

Related U.S. Application Data
(60) Provisional application No. 61/611,941, filed on Mar. 16, 2012.

(51) Int. Cl. F16L 13/10; F16L 13/00

(52) U.S. Cl. CPC F16L 13/103; F16L 13/00
USPC 285/21.3; 285/330; 156/91

(57) ABSTRACT

A pressure-rated joint includes a first pipe including a bell, and a second pipe including a portion that is disposed within the bell of the first pipe. A mechanical coupling and a chemical coupling are provided between the first pipe and the second pipe.

### CROSS-REFERENCE TO RELATED APPLICATION

This application claims priority to U.S. Provisional Patent Application No. 61/611,941, filed Mar. 16, 2012, the entirety of which is incorporated by reference herein.

### FIELD OF DISCLOSURE

The disclosed system and method relate to pipes. More particularly, the disclosed system and method relate to the connection of pipes using spline joints.

### BACKGROUND

Pipes are frequently used in numerous industries to provide a conduit through which fluids, such as oil, gas, and water, flow. Some pipes, such as PVC pipes, can be coupled together using an o-ring or other type of gasket that have limited fluid-sealing capabilities. The limitations of such seals can be exacerbated when the pressure within the pipes increases as fluid passes through them. When the pipes are used to transport hazardous materials, such as uranium, the danger and fallout from a joint failure is magnified.

### SUMMARY

In some embodiments, a pressure-rated joint includes a first pipe including a bell, and a second pipe including a portion that is disposed within the bell of the first pipe. A mechanical coupling and a chemical coupling are provided between the first pipe and the second pipe.

In some embodiments, a pressure-rated joint includes a first pipe including a bell that defines a circumferential groove about an interior of the bell and a hole that communicates with the circumferential groove. A second pipe has an external diameter that is less than an internal diameter of the bell such that the second pipe can be at least partially received within the bell. The second pipe defines a circumferential groove in an outer surface that forms a channel when aligned with the circumferential groove defined by the bell of the first pipe. A spline is disposed within the channel, and an adhesive coupling is formed between at least a portion of the first pipe and the second pipe.

In some embodiments, a method of forming a pressure-rated joint includes applying an adhesive to at least a portion of a first pipe, inserting at least a portion of a second pipe into at least a portion of the first pipe, and mechanically coupling the first pipe to the second pipe. The adhesive forms a chemical coupling between the first pipe and the second pipe.

In some embodiments, a method of forming a pressure-rated joint includes applying an adhesive to at least a portion of a first pipe, inserting at least a portion of the first pipe into at least a portion of a first pipe, and mechanically coupling the first pipe to the second pipe. The adhesive forms a chemical coupling between the first pipe and the second pipe.

### BRIEF DESCRIPTION OF THE DRAWINGS

FIG. 1A is a plan view of first and second pipes that are configured to be coupled together using a pressure-rated spline joint in accordance with some embodiments.

FIG. 1B is a cross-sectional view of the pipes illustrated in FIG. 1A taken along line 1B-1B in FIG. 1A.

FIG. 1C is a cross-sectional view of the pipes illustrated in FIGS. 1A and 1B having been joined by a pressure-rated spline joint in accordance with some embodiments.

FIG. 1D is a plan view of the pipes illustrated in FIGS. 1A and 1B having been joined by a pressure-rated spline joint in accordance with some embodiments.

FIG. 2 is a flow diagram of one example of forming a pressure-rated spline joint.

FIG. 3A is a cross-sectional view of a pair of pipes having a primer applied to certain areas prior to being coupled together in accordance with some embodiments.

FIG. 3B is a cross-sectional view of the pipes illustrated in FIG. 3A having an adhesive applied to certain areas prior to being coupled together in accordance with some embodiments.

FIG. 3C is a cross-sectional view of the pipes illustrated in FIG. 3B with one pipe being inserted into the other pipe in accordance with some embodiments.

FIG. 3D is a cross-sectional view of the pipes illustrated in FIG. 3C when the one pipe is fully seated in the other pipe in accordance with some embodiments.

FIG. 3E illustrates a spline being inserted into a channel defined by the pipes illustrated in FIG. 3D in accordance with some embodiments.

FIG. 3F is a plan view of the pipes illustrated in FIGS. 3A-3E having been coupled together using a spline joint in accordance with some embodiments.

FIG. 3G is a cross-sectional view taken along line 3G-3G in FIG. 3F of the pipes coupled together using a spline joint in accordance with some embodiments.

### DETAILED DESCRIPTION

This description of the exemplary embodiments is intended to be read in connection with the accompanying drawings, which are to be considered part of the entire written description. The drawing figures are not necessarily to scale and certain features may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. When only a single machine is illustrated, the term “machine” shall also be taken to include any collection of machines that individually or jointly execute a set (or multiple sets) of instructions to perform any one or more of the methodologies discussed herein. The term “operatively connected” is such an attachment, coupling or connection that allows the pertinent structures to operate as intended by virtue of that relationship. In the claims, means-plus-function clauses, if used, are intended to cover the structures described, suggested, or rendered obvious by the written description or drawings for performing the recited function, including not only structural equivalents but also equivalent structures.

The disclosed pressure-rated spline joint and method of forming the joint advantageously provides a fluid-tight seal between two pipes up to several hundred PSI. Such joints have a wide application including, but not limited to, the mining of hazardous materials such as, for example, uranium. Additionally, the disclosed joint can be quickly and cost-effectively assembled. The pressure-rated spine joint and method of forming the joint is described with reference to PVC pipes; however, one of ordinary skill in the art will understand that other pipe types that can be joint using adhesives, such as solvents or glues, can be utilized.

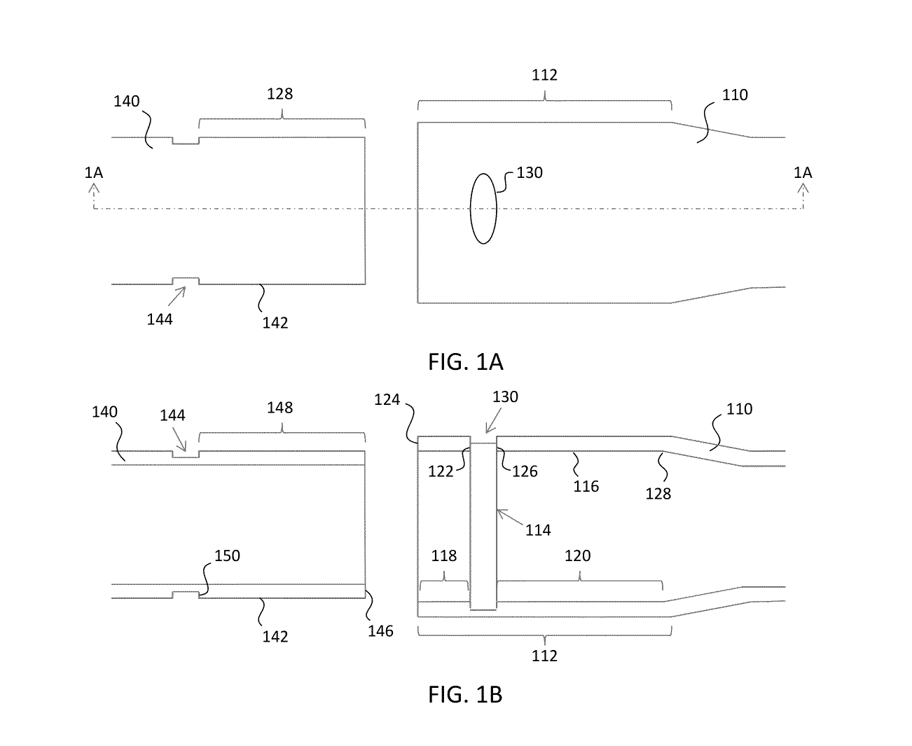

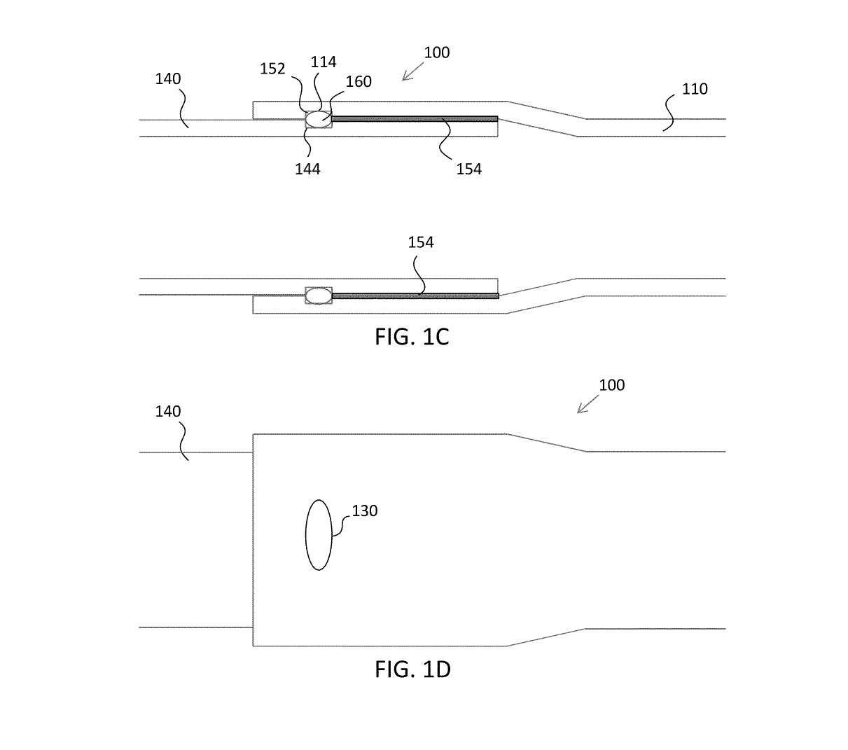

Turning now to the figures, and to FIGS. 1A and 1B in particular, a pair of pipes 110, 140 for being joined via a pressure rated spline joint 100 are illustrated. First pipe 110 includes outwardly flared bell section 112 along which a spline groove 114 is circumferentially formed on the interior surface 116 as best seen in FIG. 1B. Spline groove 114 is located along the longitudinal length of bell section 112 such that the interior surface 116 includes first and second portions 118, 120, which are located on either side of spline groove 114.

First portion 118 of interior surface 116 extends from an outer edge 122 of groove 114 to end 124 of first pipe 110. The second portion 120, which may be referred to as a weld or mating portion, extends from interior edge 126 of groove 114 to the bottom 128 of bell 112. As will be understood by one of ordinary skill in the art, the bottom 128 of bell 112 is the location at which the inner diameter of bell 112 begins tapering to the standard inner diameter of pipe 110. In some embodiments, the length of second portion 120 is greater than a length of the first portion 118. In some embodiments, first portion 118 has a length that is equal to second portion 120, and in some embodiments, the length of the first portion 118 is greater than the length of second portion 120.

A hole 130 is defined along the length of bell 112. Hole 130 is sized and configured to receive a spline 160 therein. As best seen in FIG. 1B, hole 130 is positioned longitudinally along bell 112 at a location that corresponds to where circumferential groove 114 extends around the internal surface 116 such that a spline 160 can be introduced into groove 114 through hole 130 as described in greater detail below.

Second pipe 140 has an outer diameter that is sized and configured to be received within the inner diameter of bell section 112 of pipe 110. The outer surface 142 of pipe 140 defines a circumferential groove 144 along its length adjacent to end 146 of pipe 140. In some embodiments, groove 144 is positioned along pipe 140 such that end 146 of pipe 140 is disposed adjacent to and abuts the bottom 128 of bell 112 when circumferential grooves 130, 144 align with one another. Put another way, the end portion 148 of pipe 140, which extends from outer edge 150 of groove 144 to the end 146 of pipe 140, has a length that is equal to a length of portion 120 of bell 112.

When aligned grooves 114, 144 cooperate to define a channel 152 in which spline 160 is disposed as best seen in FIG. 1C. Spline 160 may be formed from any material to provide a mechanical connection between pipes 110 and 140. In some embodiments, for example, spline 160 is formed from nylon and has a diameter of approximately ¼ inch. However, one of ordinary skill in the art will understand spline 160 can be form other plastic materials or from a rubber or metal.

A pressure-rated fluid-tight seal 154 is provided between pipes 110 and 140 using a solvent-weld seal. In some embodiments, for example, seal 154 is formed by applying a primer to at least one of pipes 110, 140 and then an adhesive or glue to the primed section. Examples of such primers and adhesives include, but are not limited to, P-70 Primer and 705 PVC both available from WELD-ON of Compton, Calif. One of ordinary skill in the art will understand that other primers and/or adhesives can be utilized.

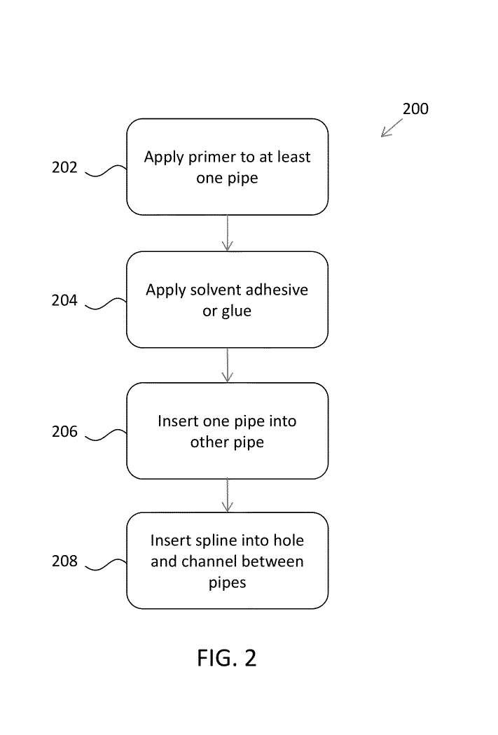

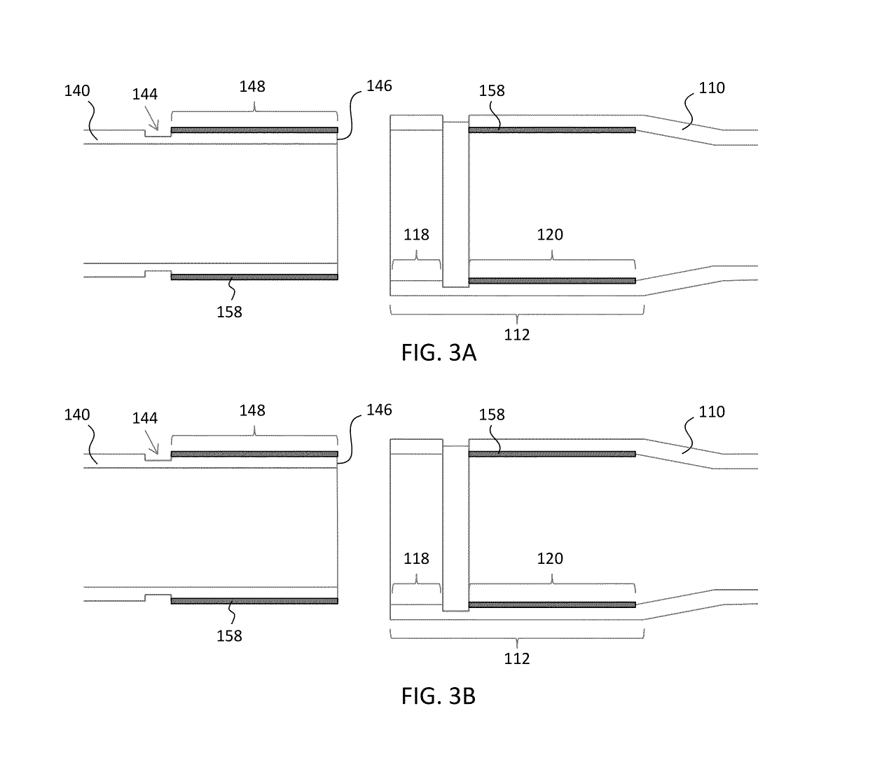

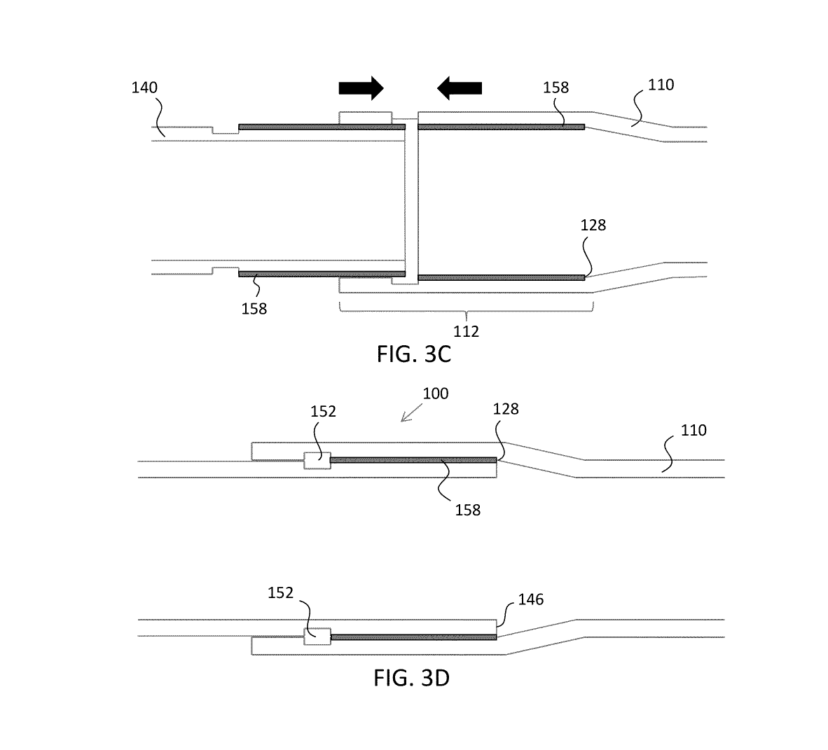

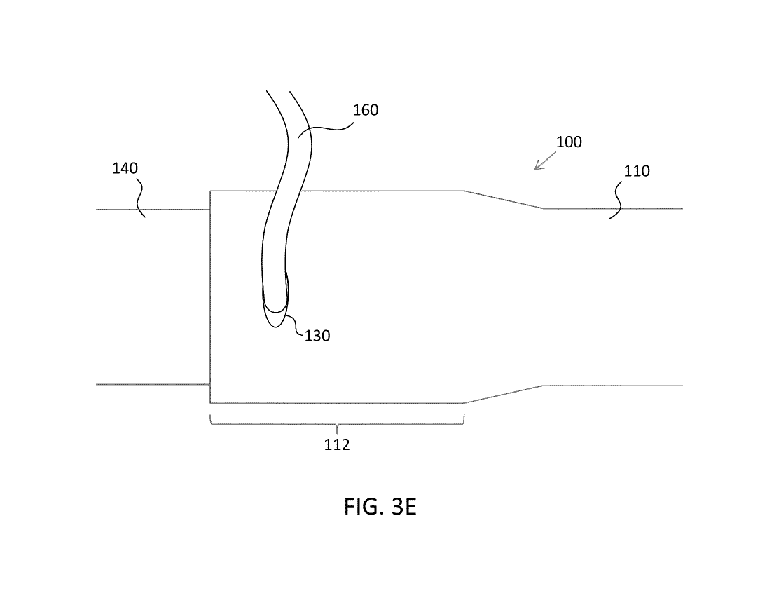

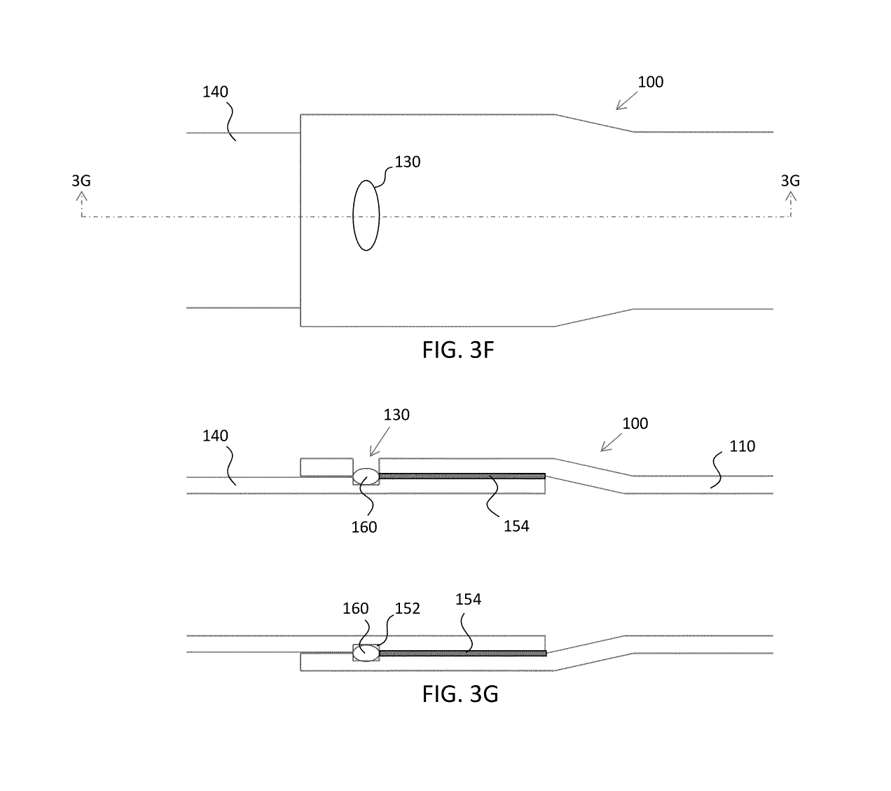

The creation of a pressure-rated spline joint 100 is described with respect to FIGS. 2 and 3A-3G in which FIG. 2 is a flow diagram of one example of a method 200 of forming a pressure-rated spline joint 100. At block 202, a primer for a solvent adhesive or glue is applied to one or both of the pipes being joined. For example and as illustrated in FIG. 3A, a primer 156 for the solvent adhesive or glue 158 is applied to the second portion 120 of the inner surface 116 of pipe 110 and to the outer surface 142 of pipe 140. In some embodiments, primer 156 is only applied to one of the second portion 120 of inner surface 116 or to the outer surface 142 of pipe 140 between groove 144 and end 146. In some embodiments, primer 156 is applied to first portion 118 and second portion 120 of inner surface 116 of pipe 110 and/or to a complementary portion of outer surface 146 of pipe 140.

Referring again to FIG. 2, a solvent glue/adhesive 158 is applied to pipes 110, 140 at block 204. In some embodiments, such as the embodiment illustrated in FIG. 3B, the solvent glue/adhesive 158 is applied to the same regions of pipes 102, 122 to which the primer 156 was applied. In some embodiments, the solvent glue/adhesive 158 is applied to regions of pipes 110, 140 that were not primed with a primer 156. In some embodiments, the combination of the primer 156 and adhesive 158 effectively melts the PVC of pipes 110 and/or 140. When allowed to “cure,” the pipes are effectively chemically bonded together to create a fluid-tight seal 154.

At block 206, second pipe 140 is inserted into first pipe 110. As shown in FIG. 3C, end 146 of pipe 140 is inserted into bell 112 of pipe 110 as illustrated by the bold arrows at the top of the figure. Pipe 140 is inserted into pipe 110 until end 146 of pipe 140 contacts bottom 128 of bell 112 and/or until groove 114 defined by pipe 110 aligns with groove 144 defined by pipe 140 to form channel 152 as illustrated in FIG. 3D.

At block 208 (FIG. 2), spline 160 is inserted into hole 130 defined by pipe 110 that communicates with channel 152 as illustrated in FIG. 3E. Although a spline 160 is described as being used to provide a mechanical connection between pipes 110 and 140, other mechanical coupling means can be used including, but not limited to, screws, a snap fit or tab and groove engagement mechanism, or a threaded connection between pipes 110 and 140 to identify just a few other possibilities.

FIGS. 3E and 3G illustrate one example of the completed joint 100 with the spline 160 disposed within channel 152 and the seal 154 having been fully formed as the adhesive has fully cured. The combination of the spline and adhesive to create a joint 100 as described herein has been tested to provide a pressure-rated seal that is able to withstand pressures of close to 1,000 psi without failure. Such joints 100 can advantageously be utilized in a wide variety of applications including mining of uranium where numerous lengths of pipe are coupled to one another and are vertically inserted into a well. The mechanical securement between the pipes enable the pipes to be coupled together and inserted into a well prior to the adhesive fully curing, and the adhesive bond provides a fluid-tight seal between the pipe segments with improved sealing compared to gaskets or other non-chemical bonds.

Although the systems and methods have been described in terms of exemplary embodiments, they are not limited thereto. Rather, the appended claims should be construed broadly, to include other variants and embodiments of the systems and methods, which may be made by those skilled in the art without departing from the scope and range of equivalents of the systems and methods.

What is claimed is:

1. A pressure-rated joint, comprising:
a first pipe including a bell;
a second pipe including a portion that is disposed within the bell of the first pipe;
a mechanical coupling between the first pipe and the second pipe; and
a chemical coupling between the first pipe and the second pipe.

2. The pressure-rated joint of claim 1, wherein a first circumferential groove is defined in an interior of the bell, and wherein a hole is defined by the bell at a location that corresponds to a location of the first circumferential groove such that the hole is in communication with the first circumferential groove.

3. The pressure-rated joint of claim 2, wherein a second circumferential groove is defined in an exterior surface of the second pipe such that a channel is created by an alignment of the first circumferential groove with the second circumferential groove.

4. The pressure-rated joint of claim 3, wherein the mechanical coupling is provided by a spline disposed within the channel.

5. The pressure-rated joint of claim 1, wherein the mechanical coupling is provided by a spline disposed within a channel defined by the first pipe and the second pipe.

6. A pressure-rated joint, comprising:
a first pipe including a bell that defines a circumferential groove about an interior of the bell and a hole that communicates with the circumferential groove;
a second pipe having an external diameter that is less than an internal diameter of the bell such that the second pipe can be at least partially received within the bell, the second pipe defining a circumferential groove in an outer surface that forms a channel when aligned with the circumferential groove defined by the bell of the first pipe;
a spline disposed within the channel; and
an adhesive coupling formed between at least a portion of the first pipe and the second pipe.

7. The pressure-rated joint of claim 6, wherein the adhesive coupling is formed between an inner edge of the circumferential groove defined by the bell and a bottom of the bell.

8. The pressure-rated joint of claim 6, wherein the adhesive coupling is formed between an outer edge of the circumferential groove defined by the bell and an end of the bell.

9. The pressure-rated spline joint of claim 6, wherein the first and second pipes are formed from PVC.

10. A method of forming a pressure-rated joint, comprising:
applying an adhesive to at least a portion of a first pipe;
inserting at least a portion of a second pipe into at least a portion of the first pipe; and
mechanically coupling the first pipe to the second pipe,
wherein the adhesive forms a chemical coupling between the first pipe and the second pipe.

11. The method of claim 10, further comprising applying the adhesive to at least a portion of the second pipe.

12. The method of claim 10, further comprising applying a primer to a portion of at least one of the first pipe or the second pipe.

13. The method of claim 10, wherein mechanically coupling the first pipe to the second pipe includes:
aligning a first circumferential groove defined by the first pipe with a second circumferential groove defined by the second pipe to provide a channel; and
inserting a spline into the channel through a hole defined by the first pipe.

14. A method of forming a pressure-rated joint, comprising:
applying an adhesive to at least a portion of a first pipe;
inserting at least a portion of the first pipe into at least a portion of a first pipe; and
mechanically coupling the first pipe to the second pipe,
wherein the adhesive forms a chemical coupling between the first pipe and the second pipe.

15. The method of claim 14, further comprising applying the adhesive to at least a portion of the second pipe.

16. The method of claim 14, further comprising applying a primer to a portion of at least one of the first pipe or the second pipe.

17. The method of claim 14, wherein mechanically coupling the first pipe to the second pipe includes:
aligning a first circumferential groove defined by the first pipe with a second circumferential groove defined by the second pipe to provide a channel; and
inserting a spline into the channel through a hole defined by the second pipe.
